(19) United States
(12) Patent Application Publication
(10) Pub. No.: US 2016/0080229 A1
(43) Pub. Date: Mar. 17, 2016

(54) APPLICATION PERFORMANCE MONITORING METHOD AND DEVICE

(71) Applicant: HITACHI, LTD., Tokyo (JP)

(72) Inventors: Emiko KOBAYASHI, Tokyo (JP); Kiyomi WADA, Tokyo (JP)

(73) Assignee: HITACHI, LTD., Tokyo (JP)

(21) Appl. No.: 14/787,519

(22) PCT Filed: Mar. 11, 2014
(86) PCT No.: PCT/JP2014/056358

§ 371 Date: Oct. 28, 2015

(51) Int. Cl. H04L 12/26

(52) U.S. Cl. CPC H04L 43/0864; H04L 43/04

(57) ABSTRACT

A response time of an access to an application is monitored, and, when a trouble may occur, an alert is given to an administrator to reduce a workload on the administrator. A response time of the application is measured, a request in which the response time exceeds a reference value is extracted, and exceeding requests are aggregated in units of predetermined time widths. An interval between adjacent time bands in which the exceeding requests are present is calculated to determine a periodical tendency of occurrence of exceeding. An alert having a level depending on the tendency is output.

### TECHNICAL FIELD

The present invention relates an application performance monitoring method and device for monitoring performance of an application system.

### BACKGROUND ART

In performance monitoring of a Web application, a method of detecting a phenomenon of performance deterioration which may cause a trouble and notifying an administrator of abnormality with an alert or the like is executed. One of performance indexes includes a response time of an application. There is a monitoring method of recording a response time from response time point for a request, comparing the response time with a reference value, and detecting performance deterioration when the response time exceeds the predetermined value. A method in which a response time is compared with a base line serving as a reference value on real time each time a request is transmitted to detect performance deterioration is disclosed in Patent Literature 1.

In formation of a base line for monitoring performance, a method of extracting a periodicity as performance tendency and making a prediction according to the periodicity to set a reference value is disclosed in Patent Literature 2.

### CITATION LIST

### Patent Literature

Patent Literature 1: WO 2013/186870A1

Patent Literature 2: JP No. 2013-214171A1

### SUMMARY OF INVENTION

### Technical Problem

In the technique disclosed in Patent Literature 1, a response time of each request is recorded on real time, and alarm notification is performed when the response time exceeds a reference time. However, as tendency of excess over the reference value, not only a case in which response times for all requests exceed the reference value at once after a certain point of time but also a case in which response times for some requests exceed the reference value sometime are given. Even though response times exceed the reference value sometime, the excesses may not occur as troubles on the system but may occur as noise by accident. Also in this case, alert notification is performed as described in the technique disclosed in Patent Literature 1, a load of an alert checking operation performed by an administrator may be increased. Thus, monitoring accuracy is improved, and it is determined whether the possibility of occurrence of a trouble caused by the tendency of performance is high. When the possibility is low, alert needs to be prevented from being raised to reduce a workload on the administrator.

In performance monitoring, as one of tendencies, a periodicity is focused as in the conventional technique disclosed in Patent Literature 2 to make it possible to extract the tendency by using time-series periodical performance data. However, the tendency cannot be easily extracted from large quantities of performance data generated at random times.

Thus, it is an object of the present invention to provide a system performance monitoring method and device that monitors a response time for access to an application and gives an alert to an administrator when a trouble may occur to reduce a workload on the administrator.

### Solution to Problems

The present invention is achieved as a system performance monitoring method which causes a computer to monitor performance of a server providing an application service in response to a request from a terminal device including the response time measurement step of measuring a response time of a request from the terminal for an application service of the server, the reference value exceeding monitoring step of extracting a request (exceeding request) in which the response time exceeds a predetermined reference value within a predetermined monitoring period and specifies a time band in which the exceeding request occurs, and the periodicity determination step of determining a periodicity of exceeding requests on the basis of a time interval between time bands in which the exceeding requests occur.

The present invention can achieve the method as a system monitoring device with a computer program.

### Advantageous Effects of Invention

According to the present invention, when a trouble may occur in system performance, an alert is given to an administrator to make it possible to reduce a workload on the administrator.

### BRIEF DESCRIPTION OF DRAWINGS

FIG. 1 is a diagram showing hardware and a logical configuration of a computer system according to a first embodiment of the present invention.

FIG. 2 is a diagram showing a configuration of a functional module of a performance monitoring program according to the first embodiment.

FIG. 3 is a diagram showing a module configuration of a response time measurement agent according to the first embodiment.

FIG. 4 is a diagram showing a flow chart of the performance monitoring program according to the first embodiment.

FIG. 5 is a diagram showing a flow chart of a reference value exceeding monitoring process of the performance monitoring program according to the first embodiment.

FIG. 6 is a diagram showing a table configuration of a request management table according to the first embodiment.

FIG. 7 is a diagram showing a table configuration of an exceeding data management table according to the first embodiment.

FIG. 8 is a diagram showing a table configuration of a determination reference management table according to the first embodiment.

FIG. 9 is a diagram showing a structure of management of requests in which response times exceed a reference value in the first embodiment.

FIG. 10 is a diagram showing a flow chart of a periodicity determination process of the performance monitoring program according to the first embodiment.

FIG. 11 are diagrams showing a table configuration of a temporary storage table used in the periodicity determination process in the first embodiment.

FIG. 12 is a diagram showing a table configuration of a periodicity data management table according to the first embodiment.

FIG. 13 is a diagram showing a flow chart of an alert determination process of the performance monitoring program according to the first embodiment.

FIG. 14 is a diagram showing a table configuration of an alert reference management table according to the first embodiment.

FIG. 15 is a diagram showing an example of an output screen in the first embodiment.

FIG. 16 is a diagram showing a table configuration of a configuration information management table according to a fourth embodiment.

FIG. 17 is a diagram showing a flow chart of an alert determination process added to the first embodiment in a fifth embodiment.

### DESCRIPTION OF EMBODIMENTS

### First Embodiment

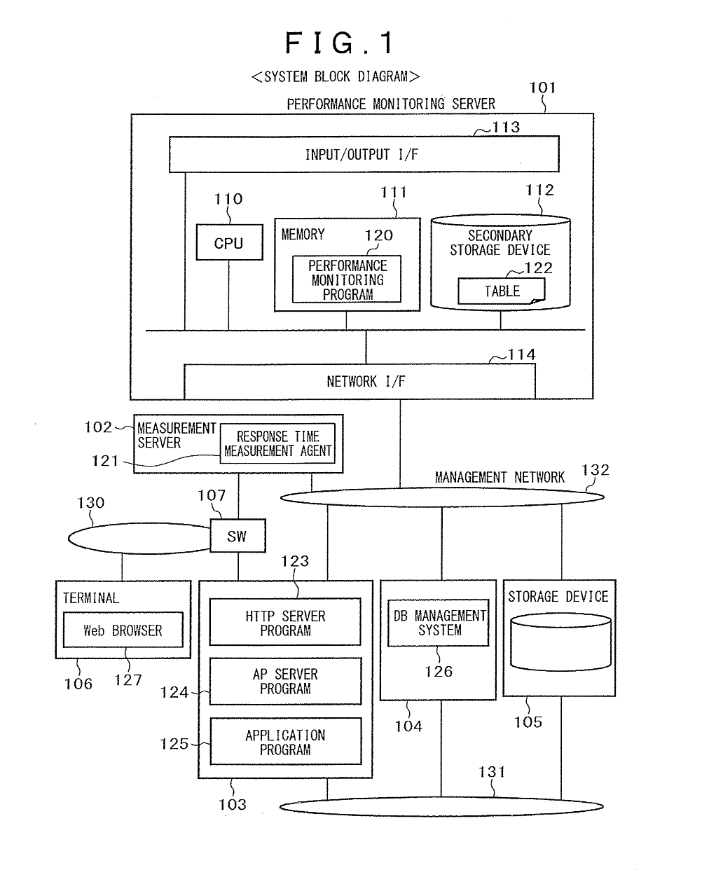

FIG. 1 is a diagram showing hardware and a logical configuration of a computer system according to a first embodiment of the present invention. This system includes a performance monitoring server 101 that monitors response performance of a response to a request for an application, a measurement server 102 that measures a response time of the response, a Web server 103 that executes a Web application, a database server 104 that manages data of the application, a storage device 105 that records and stores data, and a plurality of terminals 106 used to make users to use the Web application. The Web server 103, the database server 104, and the storage device 105 may include a plurality of Web servers, a plurality of database servers, and a plurality of storage devices, respectively.

The terminal 106 and the Web server 103 are connected to a network 130, and the measurement server 102 is connected to a switch 107 on the network. The Web server 103, the database server 104, and the storage device 105 are connected to each other by a back-end network 131. The performance monitoring server 101 is connected to each server by a management network 132.

The performance monitoring server 101 includes at least one processing device (CPU) 110, a memory 111, a secondary storage device 112 such as a hard disk drive, an input/output interface 113 that controls an input from a keyboard or a mouse and output information to a display, and a network interface 114 connected to a management network 132.

The terminal 106 has an input/output interface (not shown in the drawings) that controls an input from the keyboard or the mouse and an output to the display.

A performance monitoring program 120 is loaded on the memory 111 of the performance monitoring server 101 and executed by the CPU 110. Information of a table 122 used in the performance monitoring program 120 is stored in the secondary storage device 112. In the measurement server 102, a response time measurement agent 121 for measuring a response time of a response is executed. In the Web server 103, an HTTP (HyperText Transfer Protocol) server program 123 and an application server (to be referred to as an AP server hereinafter) program 124 serving as an application program 125 and a base thereof are executed. In the database server 104, a database management system 126 is executed. A Web browser 127 is executed in each of the terminals 106.

Each of the servers need not be mounted as a physical machine but may be mounted as a virtual machine. When the Web server is a virtual machine, the switch to which the measurement server is connected may be a virtual switch.

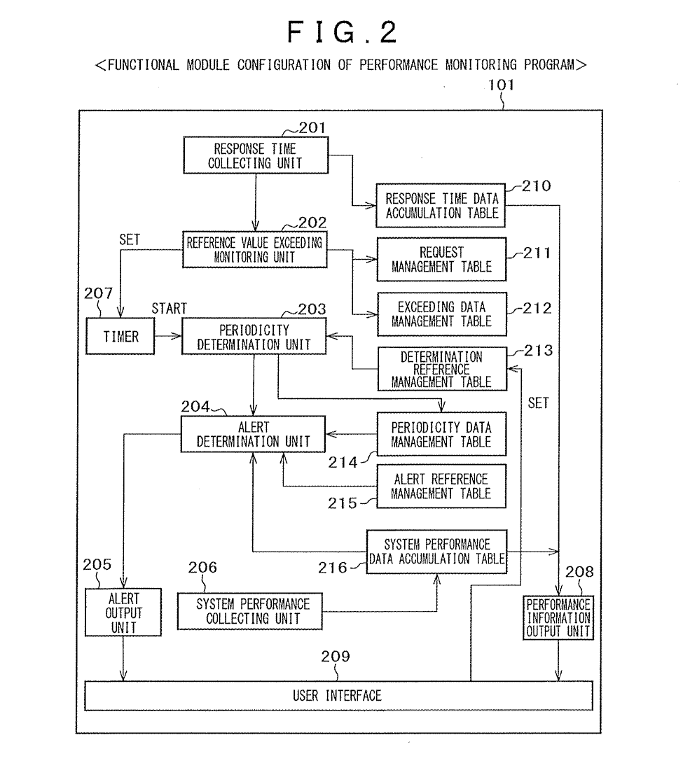

FIG. 2 shows a functional module configuration of the performance monitoring program 120. The functional module configuration includes a response time collecting unit 201 that collects request response times from the measurement server 102, a reference value exceeding monitoring unit 202 that monitors the collected response times, a periodicity determination unit 203 that determines a periodicity response occurrence times to requests (exceeding requests) in which response times exceeds a reference value, an alert determination unit 204 that determines alert transmission on the basis of a result of the periodicity determination, an alert output unit 205 that adds information to an alert to output the alert, a system performance collecting unit 206 that collects pieces of performance information such as usages of resources used in an OS or a program in the Web server 103 or the database server 104, a timer 207 to activate a module of a periodicity determination process, a performance information output unit 208 that outputs performance information such as a response time graph, and a user interface 209.

The reference time mentioned here is a specific time set as a threshold value by an administrator or a system or a value of a baseline based on past achievements automatically created by the system. Setting of the baseline may be achieved by a method disclosed in Patent Literature 1. The reference values are set in units of services, respectively, the collected response time data are managed in units of services and compared with the reference values set in the services.

The system performance collecting unit 206 collects items such as usages of resources of the Web server 103 and the database server 104 from performance monitoring agents included in both the servers 103 and 104. As another collecting method, a method configured without arranging the agents in the servers. In this case, the system performance collecting unit 206 transmits requests to the servers, respectively, to acquire the items.

The table 122 to store information in the performance monitoring program 120 includes a response time data accumulation table 210 that records a response time of a response to a request for an application, a request management table 211 that records attributes of requests in which response times exceed the reference values, an exceeding data management table 212 that collectively manages the requests in which the response times exceed the reference values in units of time widths, a determination reference management table 213 that manages a reference to determine a periodicity, a periodicity data management table 214 that manages data having a periodicity on the basis of a determination result, an alert reference management table 215 that manages a reference to determine an alert level, and a system performance data accumulation table 216 that records system performance information of the Web server 103 or the database server 104.

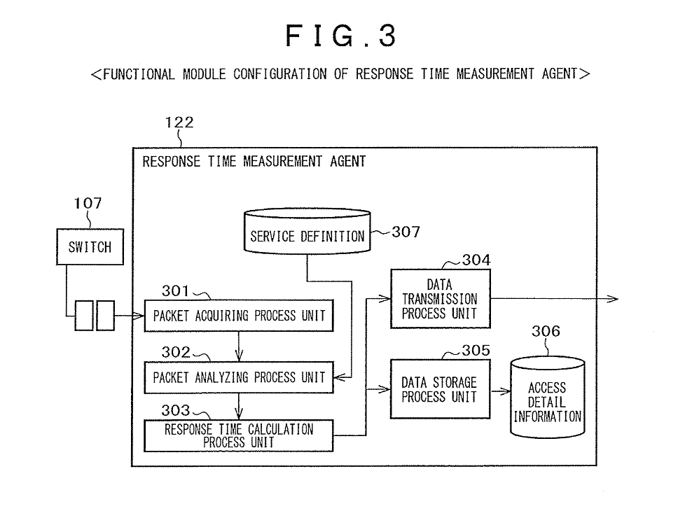

FIG. 3 shows a functional module configuration of the response time measurement agent 121 executed by the measurement server 102. The functional module configuration includes a packet acquiring process unit 301 that acquires a packet from a mirror port of the switch 107, a packet analyzing process unit 302 that analyzes a response corresponding to an HTTP request to the Web server 103 on the basis of the acquired packet, a response time calculation process unit 303 that calculates a response time on the basis of an analysis result, a data transmission process unit 304 that transmits a calculation result to the performance monitoring server 101, and a data storing process unit 305 that records access detail information 306 such as attributes of requests and responses.

In the packet acquiring process unit 301, a transmitting/receiving packet to a port, to which the Web server 103 to be monitored is connected, is acquired. In the packet analyzing process unit 302, according to service definition 307 set by the performance monitoring server 101, a specific HTTP request is identified on the basis of a packet address to the Web server 103, an attribute such as header information is recorded, and an HTTP response is identified on the basis of a packet transmitted from the Web server 103 to perform collation. In this case, the service definition 307 is to define a URL path, an URL query, and the like to be monitored as a service, and is set by an administrator and managed by the performance monitoring program 120. When the service definition 307 is changed, the performance monitoring server 101 transmits the changed information to the response time monitoring agent 121.

In the response time calculation process unit 303, a response time is calculated on the basis of a difference between packet acquisition time of the specified response and acquisition time of the request packet.

The process mentioned here in the response time measurement agent 121 may be achieved by a stream data processing system disclosed in Patent Document 1.

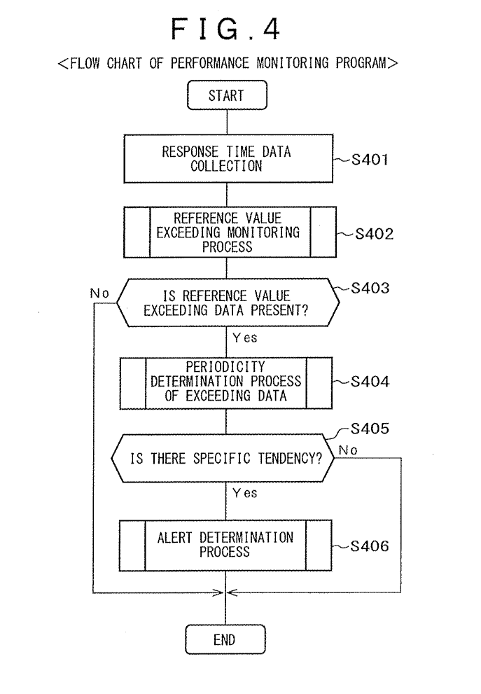

FIG. 4 is a flow chart of the performance monitoring program 120. The performance monitoring program 120 collects measurement results from the response time measurement agent 121 (S401). An object to be transmitted from the response time measurement agent 121 may be a result obtained by collecting results of each measurement or results for a predetermined period of time (for example, 1 second). After the result is received, a reference value exceeding monitoring process (S402) is called up. When there is exceeding data according to a monitoring result (S403), a periodicity determination process (S404) after a predetermined period of time has elapsed. When a periodicity or a tendency of occurrence of the exceeding data can be specified (S405), an alert determination process (S406) is called up. After the alert determination process, when there is no reference value exceeding data, or when the periodicity or the tendency of the exceeding data cannot be specified, the process is ended.

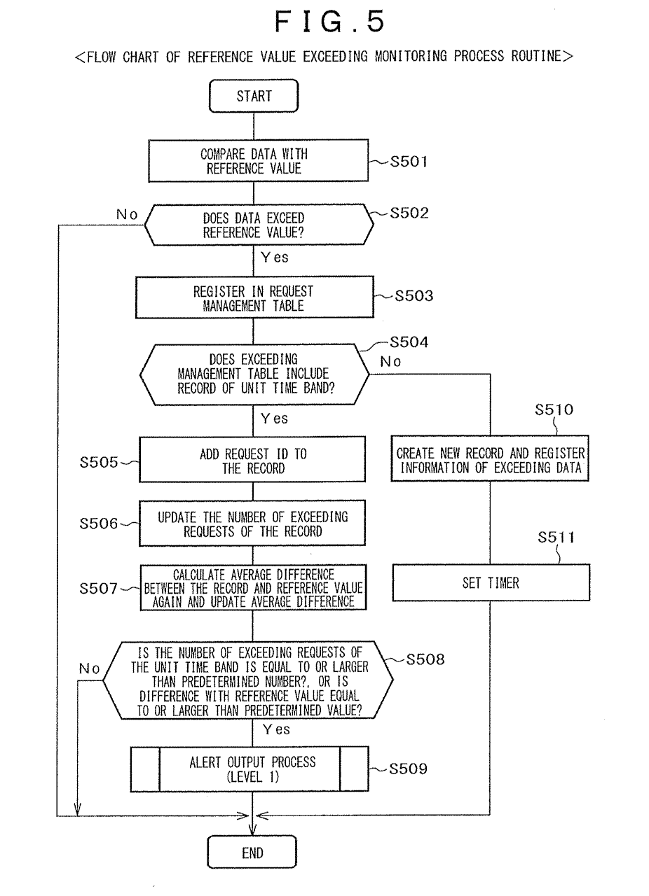

FIG. 5 shows a flow chart of a reference value exceeding monitoring process (S402 in FIG. 4) in the performance monitoring program. With respect to the collected response time data, each of the data is compared with the reference value (S501). When a response time exceeds the reference value (S502) as a result of the comparison, a new entry is registered as reference value exceeding data in a request management table (S503). The exceeding data is registered in an exceeding data management table to collectively manage the exceeding data in units of time widths of time (unit time bands). At this time, it is determined whether a record of the unit time band has been registered (S504). When a record has not been registered, a new record is created, and information of exceeding data is registered (S510). In order to determine a tendency of exceeding data obtained until a specified period of time has elapsed after the registration, a timer for notifying an administrator of a point of time at which the specified period of time has elapsed is set (S511), a time set in the timer is set in the determination reference management table 213 by the administrator or the system, and the time corresponds to a value of an “analyzing period” (802 in FIG. 8) of a selected reference.

When a record has been in the unit time band, an identifier ID of a request is added to an exceeding request ID field 703 of the exceeding data management table 212 (S505), a field 704 of the number of exceeding requests is updated (S506), and an average difference 705 between the number of exceeding requests and the reference value is calculated again and updated (S507). It is determined whether, with respect to the exceeding data in the unit time band, the number of exceeding requests is a predetermined number or more or whether the difference with the reference value is a predetermined value or more (S508). The reference value mentioned here is defined as a value set by the administrator or the system in advance. As a result of the determination, when the number is the predetermined number or more or when the difference is the predetermined value or more, a level is set to 1, an alert output process is called up (S509). Although the flow chart of the alert output process is not shown, according to the set level, an alert notification including the level and message information is created and transmitted by a method defined by the administrator or the system in advance. For example, as the method, a method of outputting the alert notification as an event and a method of transmitting the alert notification as an e-mail are given. The same is also applied to an alert outputting process called up in the subsequent flow chart.

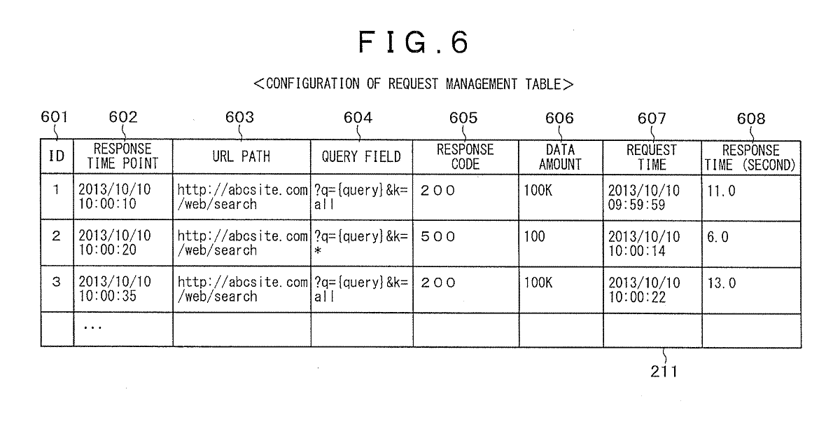

FIG. 6 shows the configuration of the request management table 211 managed by the performance monitoring program 120. This table is created for each URL of a Web application, each page including a plurality of URLs, or each transaction including URLs of a series of processes. In this case, it is assumed that the table is created for each URL. The request management table is to register information of a request in which a response time exceeds the reference value, and includes a request ID field 601 uniquely allocated to a request to be registered, a response time point field 602, a URL path field 603 which is an attribute of a request, a URL query field 604, a response code field 605 which is an attribute of a response, a transfer data amount field 606, a request time field 607 which is time information, and a response time field 608.

Records of the table created for each URL may be further classified by the response code to create another table. The records may be classified by three figures such as 100s or 200s, or may be classified by the presence/absence of errors such that classification is performed by codes having errors of 400s and 500s and the other error-free codes.

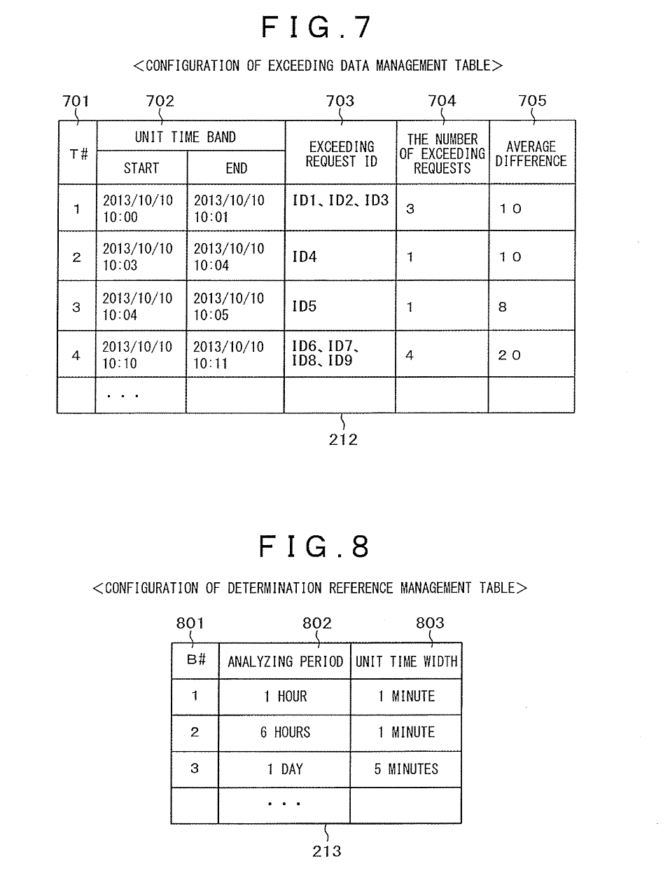

FIG. 7 shows a configuration of the exceeding data management table 212 managed by the performance monitoring program 120. The exceeding data management table 212 divides a response exceeding the reference value by unit time bands to manage the response. The time width of the unit time band is set in the determination reference management table 213 in FIG. 8 by the administrator or the system. The period of time is defined as a time width 803 of a selected reference, and 1 minute is employed as the unit time width in the example in FIG. 7. The exceeding data management table 212 includes a time band number T# field 701 to uniquely identify a record, a unit time band field 702 shown by start time and end time of the unit time band, an exceeding request ID field 703 that registers the ID of a reference exceeding request in which response time point is included in the unit time band, an exceeding request number field 704 that counts and registers the number of exceeding requests, and an average difference field 705 records a difference between an average value of response times of requests and the reference value. In this case, the start time of the time band field 702 is time which is the start time or later, and the end time is time before the end time. Subsequently, the same is also applied to time bands used in other tables.

FIG. 8 shows a configuration of the determination reference management table 213 managed by the performance monitoring program 120. The determination reference management table 213 includes a reference number field B#801 to uniquely identify a reference, an analyzing period field 802 which is a period to determine a periodicity or a tendency, and a time width field 803 of a unit time band. A value obtained by dividing the analyzing period by the time width is the number of unit time bands included in an analysis target period. Arbitrarily, through the input/output I/F 113 of performance monitoring server 101, the values of the table can be changed, or a new reference can be added to the table. The determination reference is monitored by a temporarily selected reference, periodicity extraction (will be described later) is performed, and the periodicity is compared with the previous periodicity. As a result, it may be determined that a duration is long. In this case, the performance monitoring program 120 can change the reference in use to select a reference having a long time with and a close duration again. For example, a field “1” of the reference number 801 of the determination reference management table 213 is selected, and, as a result, a reference having an average duration of 5 minutes is obtained in analysis for a time width of 1 minute. In this case, the reference is changed into a reference having a time width of 5 minutes and a field of “3” of the reference number 801. With the change, an analyzing period is changed, and a time of a timer set in detection of a subsequent exceeding request is one day.

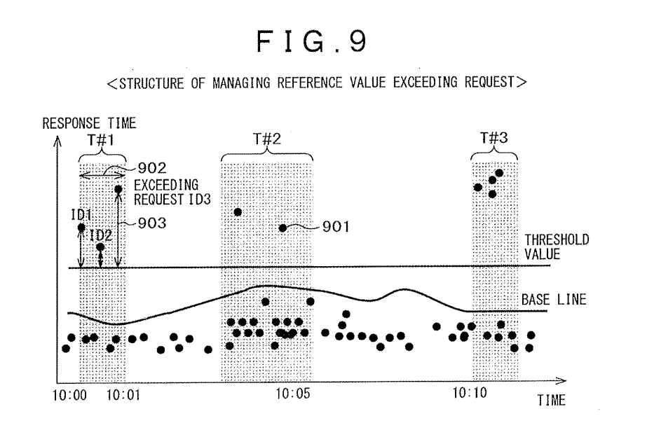

FIG. 9 is a graph showing associations between requests in which response times exceed the reference values and information registered in the management table when the requests are detected. The ordinate of the graph indicates response times of the requests, and the abscissa indicates time. A filled circle 901 in the graph is obtained by plotting response times required for a response process of one request. In this case, although both a threshold value and a base line are shown as reference values, one of them may be used as the reference value. Data exceeding the reference value is exceeding data, and is registered in the request management table 211. When a reference having reference number 1 in the determination reference management table 213 is selected, a time width 902 is one minute. Responses to three exceeding requests are generated in the time band 902 from 10:00 to 10:01, and are registered in the exceeding data management table 212. When threshold values are selected as reference values for the three requests, an average value of 10 seconds of a time 903 calculated from response times as differences with the threshold values are registered in an average difference field 705 of a row having T# of 1 in the exceeding data management table 212.

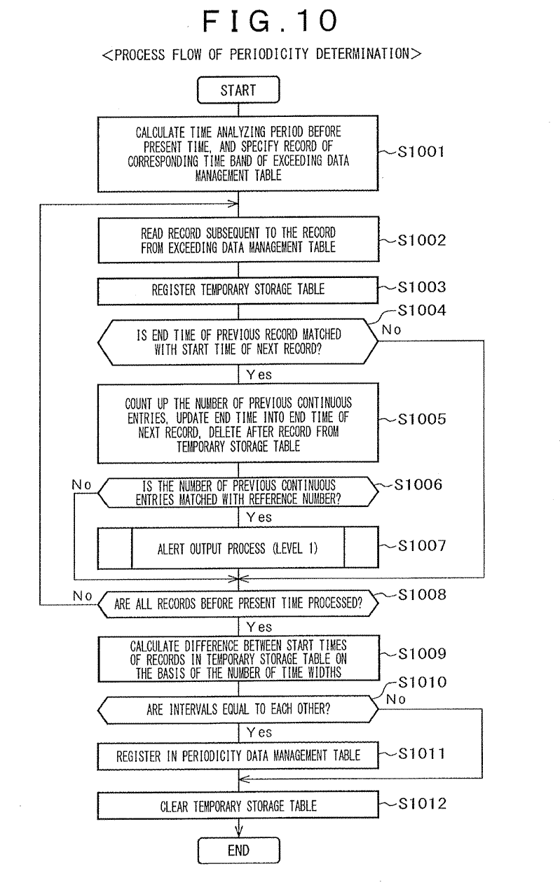

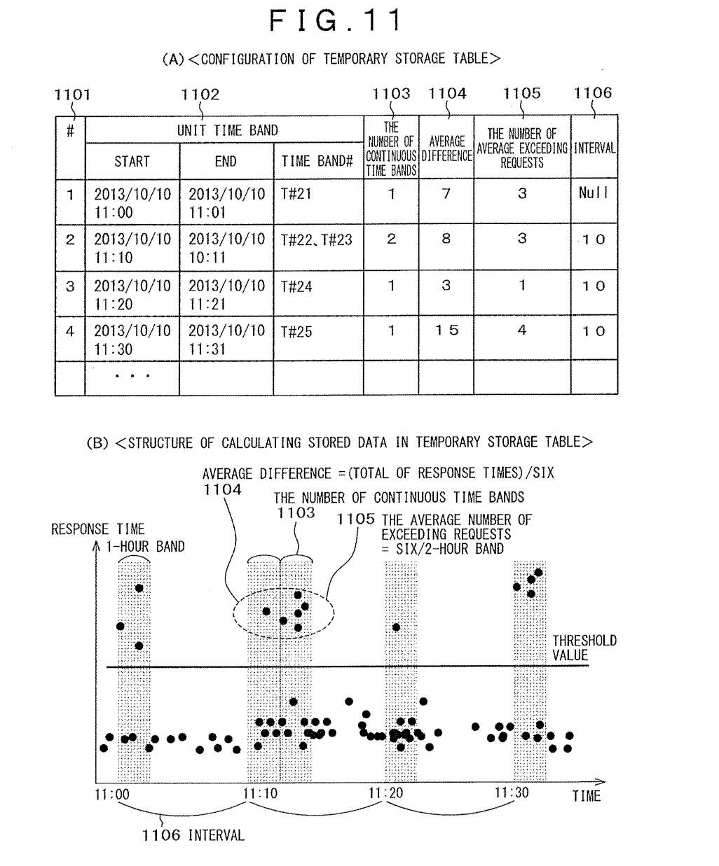

FIG. 10 is a flow chart of an exceeding data periodicity determination process (S404) in the performance monitoring program 120. This process is called up when the time of the timer set by the reference value exceeding monitoring process runs out. Time going back a predetermined analyzing period from the time when the time of timer runs out is calculated, and a specific unit time band including the calculated time in the exceeding data management table 212 is calculated. All exceeding requests included in a period from the unit time band to the unit time band including the time at which the time of the timer runs out are specified (S1001) and read (S1002).

Thereafter, the records are sequentially picked out of the time bands in the chronological order of the time bands and registered in a temporary storage table in FIG. 11A (S1003). With respect to all the registered records, it is determined whether end time of the unit time band of a previous record coincides with start time of the unit time band of the next record (S1004). When the end time coincides with the start time, it is determined that unit time bands in which response times exceed the reference values are serial. A continuous number 1103 of a previous record in the temporary storage table in FIG. 11A is counted up, end time 1102 is updated into end time of the latter record. An average difference 1104 is calculated again from the data of each of the records and updated, the latter record is deleted from the temporary storage table (S1005). Furthermore, when the updated continuous number 1103 coincides with a reference number (S1006), an alert output process is performed (S1007). The reference number mentioned here is defined as a value set in advance by the administrator or the system. The above operations are performed until all the records obtained up to now are processed in the exceeding data management table (S1008).

After all the records are processed, in order to calculate each interval between exceeding occurrence time bands, a difference between start time of each record registered in the temporary storage table and start time of the next record is calculated on the basis of the number of time widths of the unit time band (S1009). For example, when start time of a previous record and start time of the next record are 11:00 and 11:03, respectively, the interval therebetween is three times the time width of 1 minute.

As another method, a method of calculating, on the basis of the number of time widths, a difference between end time of a previous record and start time of the next record as the interval between the exceeding occurrence time bands is also given. In this case, when end time of the previous record and the start time of the next record are 11:01 and 11:03, respectively, the interval therebetween is twice the time width of 1 minute.

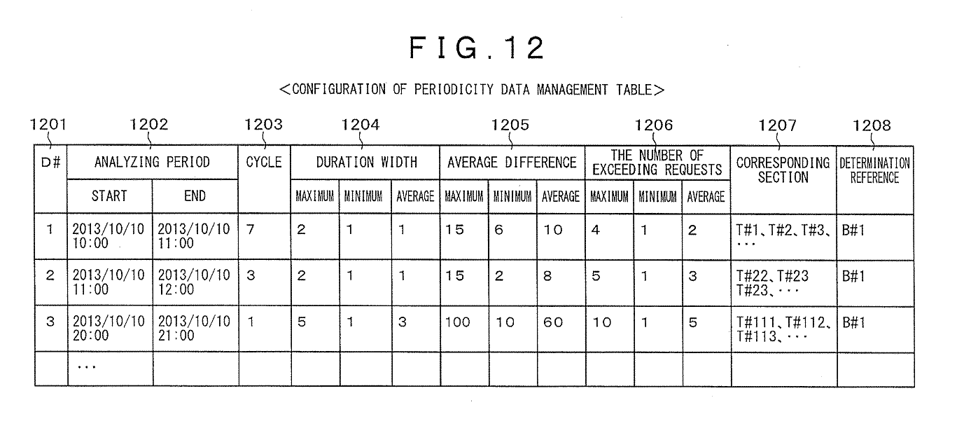

Parts having equal calculated intervals are extracted (S1010). When the intervals are equal to each other, it is determined that the data has a periodicity, and the data is registered in a periodicity management table (S1011). In the process of determining whether the intervals are equal to each other, when intervals between all analyzing periods temporarily stored are equal to each other or when a predetermined number of equal intervals are serial, it may be determined whether only the period has a periodicity. The intervals need not be completely equal to each other, and a margin of ±α (for example, ±1) may be given to the number of unit time widths of the intervals. In the periodicity data management table 214 shown in FIG. 12, start time and end time of an analyzing period 1202, an interval 1203 calculated as a periodicity, a maximum, a minimum, and an average of the continuous number field 1103 of the temporary storage table serving as a duration width 1204, and a maximum, a minimum, and an average of the average difference field 1104 serving as an average difference 1205 are registered.

In a corresponding section 1207, a time band number of the exceeding data management table 212 included in the time band of the temporary storage table is registered. As a determination reference, the determination reference number 801 of the determination reference management table 213 set in the process is registered. After the registration, the data of the temporary storage table is cleared (S1012). FIG. 11A shows a configuration of the temporary storage table. This table is temporarily used to recognize continuity of time bands in the periodicity determination process. This table includes a number field 1101 to uniquely identify data, a unit time band field 1102, the continuous number field 1103 for counting the continuous number of the unit time bands, an average difference field 1105 representing differences between continuous time bands and reference values of exceeding data as an average per continuous time band, an average exceeding request number field 1105 representing an average of the numbers of exceeding request in the continuous time bands per unit time band, and an interval field 1106 representing an interval between occurrence times as the number of time widths. FIG. 118 shows a structure for calculating data stored in the temporary storage table.

FIG. 12 shows a configuration of a periodicity data management table. This table includes a data number field 1201 to uniquely identify data, an analyzing period field 1202 representing start time and end time of an analyzing period, a cycle field 1203 representing an interval with the number of continuous time widths, a duration width field 1204 representing a maximum, a minimum, and an average of each duration of continuous time widths with the number of unit time widths, an average difference field 1205 representing a maximum, a minimum, and an average of each average difference, an exceeding request number field 1206 representing a maximum, a minimum, and an average of the number of exceeding requests, a corresponding section field 1207 representing an exceeding time band number, and a determination reference number field 1208 representing an analyzing period of a determination process and a reference of a time width.

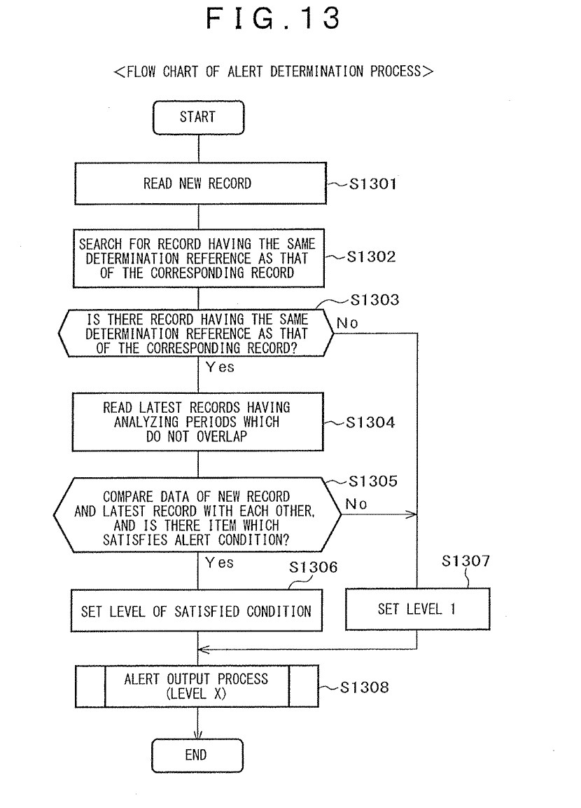

FIG. 13 shows a flow chart of an alert determination process (S406) in the performance monitoring program. Data having a record number newly registered in the periodicity data management table 214 given in a calling state is read (S1301). Records registered in the periodicity data management table 214 is searched for a record matched with a determination reference (each row of the determination reference management table 213 in FIG. 8) of the record. Since the periodicity determination process is performed in the analyzing period started from a point of response occurrence time to the first exceeding request of the unit time band, when a time interval between adjacent time bands in which exceeding requests occur is small, the analyzing periods for determining periodicities may overlap. When there are records having the same determination references (S1303), of records having analyzing periods which do not include the analyzing period for the new record, the latest record having the latest end time is read (S1304).

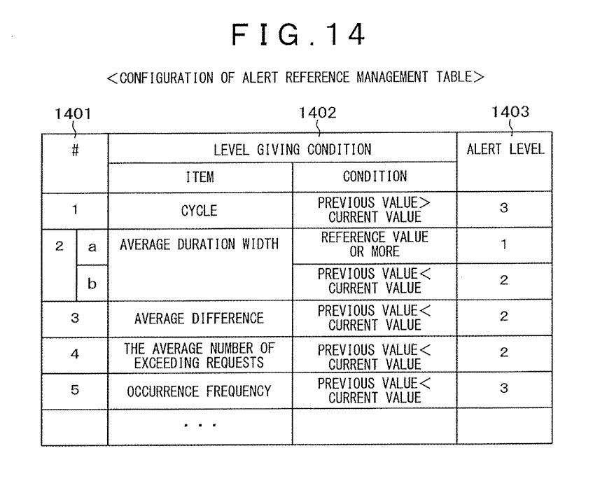

The data of the newly registered record and the latest record are compared with each other to determine whether there is an item which satisfies conditions 1402 managed in the alert reference management table 215 in FIG. 14 (S1305). When there is an item which satisfies the conditions, a level of the conditions is set as an alert level (S1306). When a plurality of items satisfy the conditions, when the levels are different from each other, a level having a larger number is set.

When there is no records having the same determination reference (S1303), or when there is no item which satisfies the conditions for the alert (S1305), level 1 is set as an alert level (S1307). The alert output process is called up (S1308), an alert for the level is output.

FIG. 14 shows a configuration of the alert reference management table 215. This table is a table for managing conditions for giving alert levels includes a number field 1401 to uniquely identify a record, a level giving condition field 1402 including an alert target item and a condition therefor as level giving conditions, an alert level field 1403. The alert level indicates a level of trouble. A larger level value means high urgency. For example, an information providing level is set to 1, an attention level is set to 2, and a warning level is set to 3.

As an alert target item, in FIG. 14, for example, a cycle, an average duration width, an average difference, the number of average exceeding requests, and a frequency of occurrence are defined. With the above configuration, it is determined whether reference value exceeding data occurring sometimes have a cycle. With the change in cycle or tendency, an appropriate alert can be given.

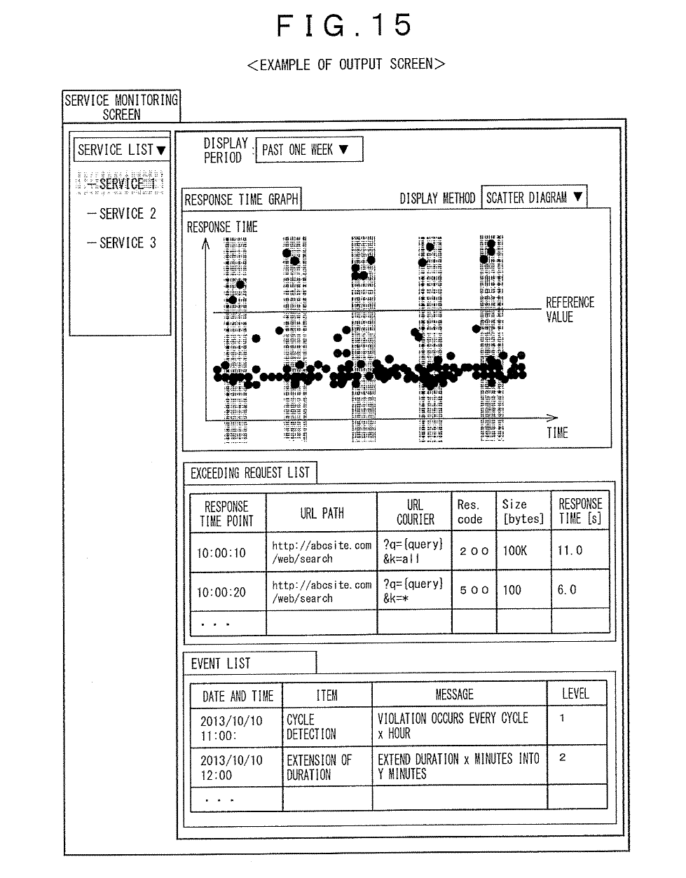

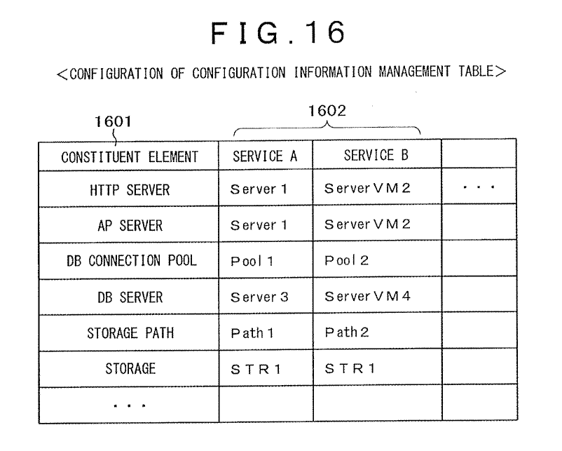

FIG. 15 shows an example of a screen output by the performance monitoring program 120. The URL of a Web application is defined as a service and managed, and a performance graph 1501 for each service is output to an upper part of the screen. A response time of performance indexes such as a response time, a throughput, and an error rate is output as a scatter diagram in which the abscissa indicates time and the ordinate indicates response times. Exceeding data for a reference value can be recognized by the administrator by indicating the line of the reference value. When a cycle pattern of the exceeding data is extracted, a band representing a cycle is output onto the graph. In this manner, the administrator understands that band-like data has a periodicity. Attributes of a request serving as exceeding data shown in the graph 1501 of the response time are output to a middle part 1502. Some or all of the data held in the request management table 211 are output. An event list is output to a lower part 1503. An alert given when the change in periodicity or tendency is detected is output as an event, and, for example, an alert which notifies that a duration is longer than a previous duration can be confirmed.

As a modification of the first embodiment, a method in which, as an analyzing period, a period from detection of an exceeding request to time when the timer is set is not targeted and a period going back from the detection of the exceeding request to the past is targeted. In the reference value exceeding monitoring process in FIG. 5, it is determined whether the corresponding time band of the exceeding data management table includes a record (S504). When the corresponding time band includes no record, and when a new record is added to the table, the periodicity determination process is called up without setting the timer. In the periodicity determination process, it is determined whether an occurrence tendency of exceeding request from time when the periodicity determination process is called up to time going back to the past but to time after an analyzing period has elapsed. When the corresponding time band has included a record in S504, since the periodicity determination process to the time band has been performed, the periodicity determination process is not called up. The periodicity determination process and the alert determination process are as described above.

The performance monitoring server 101 and the measurement server 102 may be the same server. The performance monitoring program 120 and the response time measurement agent 121 may be integrated with each other into one program.

### Second Embodiment

In the first embodiment described above, a periodicity is determined on the basis of intervals between time bands in which exceeding requests are present, and the change of the periodicity determines an alert level. The second embodiment describes a method of determining an alert level with a change in occurrence frequency of reference value exceeding requests without using a periodicity.

In the first embodiment, it is determined on the basis of intervals between time widths in each of which exceeding occurs in steps S1009 to S1011 in FIG. 10 whether the exceeding occurs in a cycle. In the second embodiment, in this step, a ratio of the number of unit time bands in each of which exceeding occurs to the total number of unit time bands in the analyzing period is calculated and defined as an occurrence frequency. Continuous unit time bands are counted one by one. In the example in FIGS. 11A and 11B, when the analyzing period and the time width are given by 1 hour and 1 minute, respectively, it is determined that exceeding occurs in five time widths. In this case, a frequency is given as 5/60 (0.08). When exceeding occurs in ten time widths in the next analysis, a frequency is given as 10/60 (0.17).

In the alert reference management table 215 in FIG. 14, an occurrence frequency is registered in record #5 in the number field 1401 in advance. When the frequency is matched with the reference, i.e., when the frequency is higher than the previous frequency, an alert is output at level 3.

As described above, a change in occurrence frequency is determined as a tendency of exceeding occurrence, so that an appropriate alert can be given.

### Third Embodiment

A third embodiment is another embodiment of the periodicity determination process, and describes a method of using a well-known Fourier transform process to specify whether there is a periodicity. In order to calculate a cycle of occurrence of exceeding requests, response time data generated at random times are not directly processed, and in the periodicity determination process based on binary information representing the presence/absence of an exceeding request in each time width obtained as a result of the reference value exceeding monitoring process in FIG. 5 in the first embodiment, with respect to an analyzing period, a time band in which an exceeding request is present is set to 1, and a time band in which an exceeding request is absent is set to 0 to create time-series data. The Fourier transform process is performed to the created data to extract a cycle of frequencies included in the analyzing period. When a plurality of frequencies can be extracted, the frequencies are registered as frequency data. The subsequent processes are the same as those in the first embodiment.

### Fourth Embodiment

In a fourth embodiment, in addition to the information managed in the first embodiment, configuration information of the system such as an OS of the host is managed and used in the periodicity determination process and the alert determination process. The embodiment describes a method in which the configuration information and a configuration change log are used, and, without analyzing data before and after the change of the configurations, the determination process in the first embodiment is performed in only the same configuration. FIG. 16 shows a configuration information management table for managing constituent elements of the system. As constituent elements 1601, in addition to an HTTP server program 123, an AP server program 124, a host which executes a database management system 126, and the storage device 105 which stores data of a database, a connection pool to a database server, a path to the storage device, and the like serving as shared resources are given. The constituent elements are registered and managed in units of services 1602.

Furthermore, of logs of the constituent elements, a log related to a change of configuration is managed. As a log collecting method, a method of arranging agents in a target host, periodically searching for logs, and transmitting the logs to a performance monitoring server, a method in which a log management server is set, a host transmits a system log to the log management server, and the performance monitoring server acquires a log related to a change in configuration from the log management server, and the like are given. The change in configuration means updating of the OS of the host or the server program, migration to another physical machine when the host is a virtual machine, a change in specification of hardware, and the like.

In the periodicity determination process in FIG. 10, time before an analyzing period is calculated in step S1001. At this time, the constituent elements of an object service are read from the configuration information management table in FIG. 16 to specify a host. Searching is started from a log for managing log information of the host to check whether a change in configuration is performed in a period from time before the analyzing period to the current time. When the change in configuration is not performed, the subsequent processes are the same as those in the first embodiment. When a log of the change in configuration can be specified, the latest time of the configuration change log is specified. In a process (S1002) of reading a record from the exceeding data management table 212, in a time band after the latest time of the change in configuration, records are sequentially read from a record of the latest time band. The subsequent processes are the same as those in the first embodiment.

Furthermore, also in the alert determination process in FIG. 13, when the latest record in step S1304 is read out, it is checked by searching for a log whether a change in configuration is not performed for a period between the current analyzing period and the analyzing period of the latest record. When the change in configuration is not performed, the subsequent processes are the same as those in the first embodiment. When the log of the change in configuration can be specified, the latest record is a record obtained before the change in configuration. For this reason, comparison is not performed, and level 1 is set to end the process (S1307).

### Fifth Embodiment

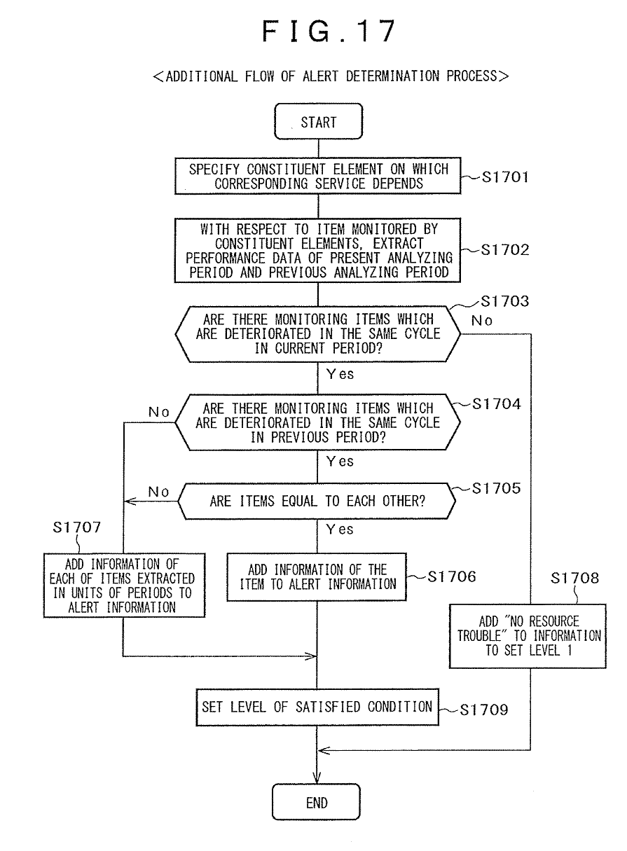

As another method using the configuration information, a method of adding system such as a usage of system resources to conditions for alert determination in the alert determination process is disclosed. Determination conditions are added in the alert determination process in FIG. 13 described in the first embodiment. A process shown in FIG. 17 is performed between step S1305 and step S1308 in FIG. 13.

After step S1305, when it is determined that a cycle is present, constituent elements on which the service depends are specified on the basis of the configuration information management table (S1701).

The performance monitoring program 120, as described in the first embodiment, a monitoring item is set for each of the constituent element to monitor information of the target host, the information is collected by the system performance collecting module and stored in the system performance data accumulation table 216. With respect to the monitoring items of the specified constituent elements, performance data in the current analyzing period and the previous analyzing period are extracted (S1702).

With respect to the data in the current analyzing period, in a time band of the obtained cycle, it is checked whether system performance items include items (the usages of which increase) which are similarly deteriorated (S1703). When the items having similar tendencies are present, with respect to the data in the previous analyzing period, it is checked whether an item which is similarly deteriorated in comparison with the previous cycle is present (S1704). When the items at this time are matched with previous items (S1705), information (host names, item names, and the like) of the items is added to the alert information (S1706). There is no similar tendency, it is determined that a trouble does not occur in the resources, and level 1 is set to add information representing no resource trouble to the alert information (S1708).

When the monitoring items extracted in the current analyzing period are different from the monitoring items extracted in the previous analyzing period, pieces of item information are added to the alert information in units of periods (S1707).

Although not shown in the flow chart, when there is no record which satisfies the alert conditions in step S1305 in FIG. 13, with respect to only the data in the current analyzing period, in the time band of the obtained cycle, it is checked whether system performance items include items (the usages of which increase) which are similarly deteriorated. When the items are present, item information is added to the alert information.

Furthermore, in addition to the performance of the system resources, a method of adding the number of accesses to the determination conditions will be described below. In addition to the process of the response time monitoring agent 121 of the first embodiment, the number of accesses including a request which cannot obtain a response is counted, and the number of accesses is periodically transmitted to the performance monitoring server. In the performance monitoring server, the collected number of accesses is stored in the database. When an item in which system performance in the analyzing period is deteriorated is extracted, the number of accesses to the service in the analyzing period is read from the accumulated data. It is determined whether the number of accesses increases in a similar time band. Also in the previous analyzing period, it is determined whether the number of accesses in the same time band increases. When the numbers of accesses in both the previous analyzing period and the current analyzing period, the level is set to 1, information representing the increase in number of accesses is added to the alert. When the number of accesses does not increase in the current analyzing period, the level is not changed, and information representing no increase in number of accesses is added to the alert. When the number of accesses does not increase in the previous analyzing period and the number of accesses increases in the current analyzing period, the level is not changed, information representing the increase in number of accesses is added to the alert.

As described above, a tendency of system performance and a tendency of the number of accesses are associated with an exceeding tendency of a response time of a request to make it possible to output an appropriate alert.

### REFERENCE SIGNS LIST

101: performance monitoring server,
102: measurement server,
103: Web server,
104: database server,
105: storage device
106: terminal,
107: network switch
120: performance monitoring program,
121: response time measurement agent,
123: HTTP server program
124: application server program,
125: application program,
126: database management system

1. An application performance monitoring method of causing a computer to monitor performance of an application which provides an application service in response to a request from a terminal device, comprising:
the response time measurement step of measuring a response time of a request from the terminal device for an application service of the server;
the reference value exceeding monitoring step of extracting a request (exceeding request) in which the response time exceeds a predetermined reference value within a predetermined monitoring period and specifies a time band in which the exceeding request occurs; and
the periodicity determination step of determining a periodicity of exceeding requests on the basis of a time interval between time bands in which the exceeding requests occur.

2. The application performance monitoring method according to claim 1, wherein
in the reference value exceeding monitoring step, the monitoring period is divided into a plurality of sections by a time band (unit time band) having a predetermined time width (unit time width), and
exceeding requests are extracted in units of unit time bands to specify a time band in which the exceeding request occurs, and
in the periodicity determination step,
a time interval between time bands in which exceeding requests occur is calculated on the basis of the number of unit time widths, and
when the numbers of unit time widths are equal to each other in two or more serial intervals, the number of unit time widths is determined as a cycle.

3. The application performance monitoring method according to claim 2, wherein
a present cycle determined in the periodicity determination step is shorter than a cycle determined at time the monitoring period or longer ago, an alert is output to the terminal device.

4. The application performance monitoring method according to claim 2, wherein
in the reference value exceeding monitoring step, an exceeding request is present across a plurality of unit time bands,
the number of continuous unit time bands is counted, and
when the present number of continuous unit time bands is larger than the number of continuous unit time bands obtained the monitoring period or longer ago, an alert is output to the terminal device.

5. The application performance monitoring method according to claim 2, wherein
in the reference value exceeding monitoring step, an average value of differences between response times of exceeding request per unit time band and the predetermined reference value is calculated and managed as an average difference, and
when the present average difference is larger than a previous average difference obtained the monitoring period or longer ago, an alert is output to the terminal device.

6. The application performance monitoring method according to claim 2, wherein
in the reference value exceeding monitoring step, the average number of exceeding requests per unit time band is calculated and managed, and, when the present average number of exceeding requests is larger than the average number of exceeding requests obtained the monitoring period or longer ago, an alert is output to the terminal device.

7. The application performance monitoring method according to claim 2, wherein
in the reference value exceeding monitoring step, the number of unit time bands in which exceeding requests are present within the monitoring period, the resultant value is divided by the total number of unit time bands in the monitoring period to obtain a value as an occurrence frequency, and, when the present occurrence frequency is higher than an occurrence frequency obtained the monitoring period or longer ago, an alert is output to the terminal device.

8. The application performance monitoring method according to claim 2, wherein
a graph of the response times is output to the terminal device, on the response time graph,
time bands in which two or more time intervals between adjacent time bands in which exceeding requests are present are colored, and
the time intervals are displayed as a cycle.

9. An application performance monitoring device which monitors performance of an application for providing an application service in response to a request from a terminal device, comprising:
a processing device which executes a program (performance monitoring program) for monitoring the performance of the application; and
a storage unit which stores the performance monitoring program and a management table used to monitor the performance, wherein
the processing device executes the performance monitoring program to have
a response time measurement function of measuring a response time of a request from the terminal device for the application service,
a reference value exceeding monitoring function of
extracting a request (exceeding request) in which the response time exceeds a predetermined reference value,
dividing the monitoring period into a plurality of sections by a time band (unit time band) having a predetermined time width (unit time width) to extract an exceeding request in each of the unit time bands, and
specifying a time band in which an exceeding request occurs within the monitoring period, and
a periodicity determination function of determining a periodicity of response time exceeding on the basis of a time interval between the time bands in which the exceeding requests occur.

10. The application performance monitoring device according to claim 9, wherein
the storage unit stores, as the management table, an exceeding data management table having, as attribute items, by using each unit time band having the exceeding request as one record,
serial numbers of the unit time bands,
start time and end time of each of the unit time bands,
an identification number of an exceeding request which is present in the unit time band, and
an average value (average difference) of differences between response times of the exceeding requests per unit time band and the reference value, and
after the processing device extracts an exceeding request of each of the unit time bands, and an extraction result is recorded in a field of the corresponding unit time band of the table.

11. The application performance monitoring device according to claim 9, wherein
in the periodicity determination function, a time interval between time bands in which the exceeding requests occur is calculated on the basis of the number of unit time widths, when the numbers of unit time widths are equal to each other in two or more serial intervals, the number of unit time widths is determined as a cycle,
the storage unit stores, as the management table, a periodicity data management table having, as attribute items, by using each of the analyzing periods as one record,
serial numbers of the analyzing periods,
the cycle,
an average value of duration widths which are serial numbers of the unit time bands when an exceeding request is present across a plurality of unit time bands,
an average value of average differences which are average values between response times of the exceeding requests per unit time band and a predetermined difference value,
an average value of the number of exceeding requests, and
a number of a unit time band in which an exceeding request is present within the analyzing period,
when aggregation of the exceeding requests in the analyzing periods is finished, the processing device records an aggregation result in a field of the corresponding analyzing period of the table, and, when any one of the values described in the table is larger than a predetermined value or a value obtained the analyzing period or longer ago, the processing device outputs an alert to the terminal device.
